(19) United States
(12) Patent Application Publication
(10) Pub. No.: US 2005/0229206 A1
(43) Pub. Date: Oct. 13, 2005

(54) Television signal receiver capable of receiving emergency alert signals

(76) Inventors: Michael Anthony Pugel, NOBLESVILLE, IN (US); John Douglas Merrell, Noblesville, IN (US); Scott Allan Kendall, Westfield, IN (US); David Emery Virag, Indianapolis, IN (US); Michael Alan Bridge, Noblesville, IN (US)

Correspondence Address: Joseph S Tripoli;Thomson Licensing Inc, P O Box 5312, Princeton, NJ, 08543-5312, US

(21) Appl. No.: 10/513,903

(22) PCT Filed: May 9, 2003
(86) PCT No.: PCT/US03/14650

§ 371 Date: Nov. 9, 2004

Related U.S. Application Data
(60) Provisional application No. 60/379,695, filed on May 10, 2002.
(60) Provisional application No. 60/426,955, filed on Nov. 15, 2002.

(51) Int. Cl. H04N 7/10

(52) U.S. Cl. 725/33

(57) ABSTRACT

A television signal processing system having an emergency alert function is capable of receiving emergency alert signals and providing alert outputs to notify individuals of emergency events. According to one exemplary embodiment, the television signal processing system includes a tuner operative to tune a frequency including emergency alert signals indicating an emergency event. A processor is operative to enable an alert output responsive to the emergency alert signals when the emergency event indicated by the emergency alert signals corresponds to a geographical area selectable by a user. According to another exemplary embodiment, the processor is operative to enable an alert output responsive to the emergency alert signals when the emergency event indicated by the emergency alert signals corresponds to a predetermined event selectable by a user.

### CROSS REFERENCE TO RELATED APPLICATIONS

This application claims priority to and all benefits accruing from two provisional applications filed in the United States Patent and Trademark Office on May 10, 2002 and Nov. 15, 2002, and there assigned Ser. Nos. 60/379,695 and 60/426,955, respectively.

### BACKGROUND OF THE INVENTION

1. Field of the Invention

The present invention generally relates to television signal processing systems, and more particularly, to television signal processing systems capable of, among other things, receiving a signal indicating an emergency event and providing alert outputs including one or more visual displays to notify individuals of emergency events.

2. Background Information

Emergency events such as severe weather, natural disasters, fires, civil emergencies, war acts, toxic chemical spills, radiation leaks, or other such conditions can be devastating to unprepared individuals. With weather-related emergencies, authorities such as the National Weather Service (NWS) and the National Oceanographic and Atmospheric Administration (NOM) are generally able to detect severe weather conditions prior to the general public. Through the use of modern weather detection devices, such as Doppler radar and weather satellites, the NWS and NOM are able to issue early warnings of severe weather conditions which have saved many lives. However, for such warnings to be effective, they must be communicated to their intended recipients.

Certain specialized radios and scanners are capable of receiving emergency alert signals provided by the NWS and NOM. However, such devices tend to be dedicated to this use, and generally offer consumers little, if any, functionality beyond monitoring these signals. Accordingly, in order to receive advance warning of weather-related emergencies, consumers are required to purchase a separate, dedicated device, which may be cost-prohibitive to some consumers.

Accordingly, there is a need for a device capable of receiving emergency alert signals which avoids the foregoing problems. The present invention addresses these and other issues.

### SUMMARY OF THE INVENTION

In accordance with an aspect of the present invention, a television signal processing system having an emergency alert function is disclosed. According to an exemplary embodiment, the television signal processing system comprises tuning means for tuning a frequency including a signal indicating an emergency event. Processing means enable an alert output responsive to the emergency alert signals when the emergency event indicated by the emergency alert signals corresponds to a geographical area selectable by a user. According to another exemplary embodiment, the processing means enable an alert output responsive to the emergency alert signals when the emergency event indicated by the emergency alert signals corresponds to a predetermined event selectable by a user.

In accordance with another aspect of the present invention, a method for controlling a television signal processing system having an emergency alert function is disclosed. According to an exemplary embodiment, the method comprises steps of tuning a frequency including a signal indicating an emergency event, and providing an alert output responsive to the emergency alert signals when the emergency event indicated by the emergency alert signals corresponds to a geographical area and a predetermined event selectable by a user.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is an exemplary environment suitable for implementing the present invention;

FIG. 2 is a block diagram of a television signal processing system according to an exemplary embodiment of the present invention;

FIG. 3 is a block diagram of a television signal processing system according to another exemplary embodiment of the present invention;

FIG. 4 is a flowchart illustrating exemplary steps according to the present invention;

FIG. 5 is a diagram illustrating an exemplary technique for providing a visual alert output according to the present invention; and

FIG. 6 shows further exemplary details of the emergency event indicator of FIG. 5.

The exemplifications set out herein illustrate preferred embodiments of the invention, and such exemplifications are not to be construed as limiting the scope of the invention in any manner.

### DESCRIPTION OF THE PREFERRED EMBODIMENTS

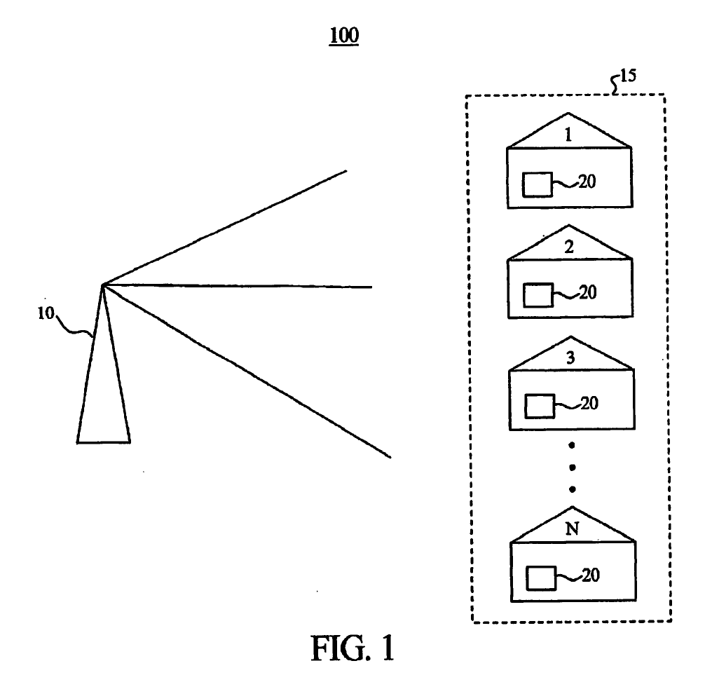

Referring now to the drawings, and more particularly to FIG. 1, an exemplary environment 100 suitable for implementing the present invention is shown. In FIG. 1, environment 100 comprises a signal transmission source 10 and dwelling units 15 (i.e., 1, 2, 3 . . . N, where N may be any positive integer). Dwelling units 15 in FIG. 1 may for example represent residences, businesses and/or other dwelling places located within a particular geographical area, such as but not limited to, a particular continent, country, region, state, area code, zip code, city, county, municipality, subdivision, and/or other definable geographical area. According to an exemplary embodiment, each of the dwelling units 15 is equipped with at least one television signal processing system, or television signal processor, 20 capable of receiving a signal indicating an emergency event, e.g., emergency alert signals, and providing alert outputs to notify individuals of emergency events.

The television signal processing system may comprise various types of systems or signal processors such as television signal receivers that include a display device (such as a television set) or television signal receivers that do not include a display device (such as a set top box or VCR) but produce a signal suitable for coupling to a display device. For the purposes of the following detailed description, an exemplary embodiment of a system incorporating principles of the invention will be described in the context of a television signal receiver that includes a display device. However, the described aspects of the invention are also applicable to other types of television signal processing systems such as those that do not include a display device.

According to an exemplary embodiment, signal transmission source 10 transmits signals including a signal indicating an emergency event, e.g., emergency alert signals, which may be received by each television signal receiver 20. The emergency alert signals may be provided from an authority such as the NWS, or other authorities such as governmental entities or the like. In response to the emergency alert signals, each television signal receiver 20 may perform an emergency alert function by providing one or more alert outputs to thereby notify individuals of the emergency event. Signal transmission source 10 may, for example, transmit such emergency alert signals to television signal receivers 20 via any wired or wireless medium such as, but not limited to, terrestrial, cable, satellite, fiber optic, digital subscriber line (“DSL”), and/or other type of broadcast and/or multicast means.

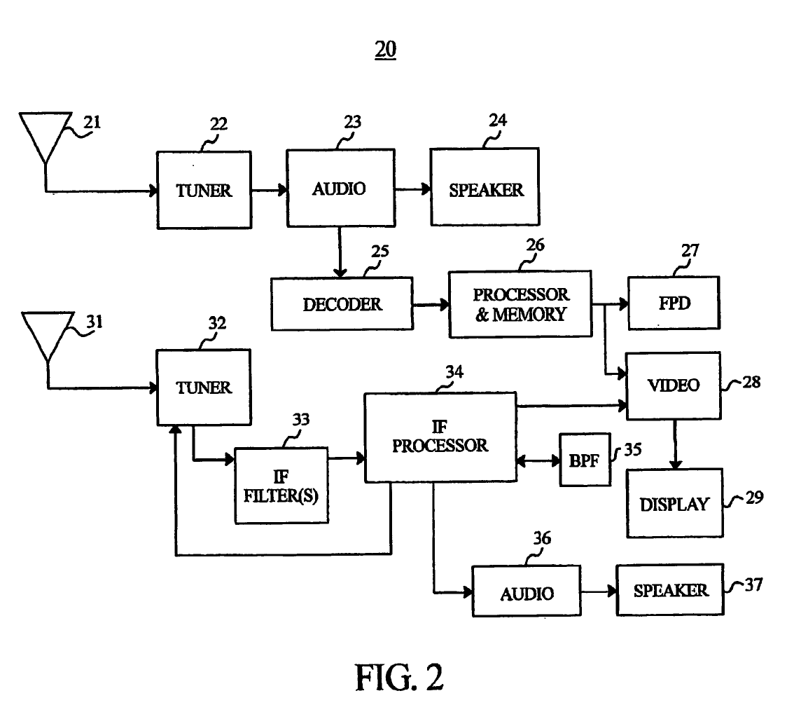

Referring to FIG. 2, a block diagram of an exemplary embodiment of television signal receiver 20 of FIG. 1 is shown. In FIG. 2, television signal receiver 20 comprises a signal receiving element 21, a tuner 22, an audio processor 23, a speaker 24, a decoder 25, a processor and memory 26, a front panel display (FPD) 27, a video processor 28, a display 29, a signal receiving element 31, a tuner 32, one or more intermediate frequency (IF) filters 33, an IF processor 34, a band pass filter (BPF) 35, an audio processor 36, and a speaker 37. Some of the foregoing elements may for example be embodied using integrated circuits (ICs). For clarity of description, certain conventional elements of television signal receiver 20 may not be shown in FIG. 2.

Signal receiving element 21 is operative to receive signals including audio signals from signal sources, such as signal transmission source 10 in FIG. 1. According to an exemplary embodiment, received audio signals may include digitally encoded emergency alert signals. Signal receiving element 21 may be embodied as any signal receiving element such as an antenna, input terminal or other element.

Tuner 22 is operative to tune signals including audio signals provided from signal receiving element 21 which may additionally include digitally encoded emergency alert signals. According to an exemplary embodiment, tuner 22 is capable of tuning audio signals on at least the following designated NWS frequencies: 162.400 MHz, 162.425 MHz, 162.450 MHz, 162.475 MHz, 162.500 MHz, 162.525 MHz and 162.550 MHz. Other frequencies may also be tuned. As previously indicated herein, such audio signals may additionally include digitally encoded emergency alert signals.

Audio processor 23 is operative to process audio signals provided from tuner 22. According to an exemplary embodiment, audio processor 23 demodulates such audio signals to thereby generate demodulated audio signals representing audio content such as an NWS audio message, a warning alert tone and/or other audio content. Audio processor 23 is further operative to amplify the demodulated audio signals. Speaker 24 is operative to aurally output the amplified audio signals provided from audio processor 23.

Decoder 25 is operative to decode signals including demodulated audio signals provided from audio processor 23. According to an exemplary embodiment, decoder 26 decodes such audio signals to thereby extract digitally encoded frequency shift keyed (FSK) signals, which represent emergency alert signals indicating an emergency event. According to this exemplary embodiment, the emergency alert signals include data comprising specific area message encoding (SAME) data associated with the emergency event. SAME data comprises a digital code representing information such as the specific geographical area affected by the emergency event, the type of emergency event (e.g., tornado, toxic chemical spill, radiation leak, civil emergency, etc.), and the expiration time of the event alert. SAME data is used by the NWS and other authorities to improve the specificity of emergency alerts and to decrease the frequency of false alerts. Other data and information may also be included in the emergency alert signals according to the present invention.

Processor and memory 26 are operative to perform various processing and data storage functions of television signal receiver 20. According to an exemplary embodiment, processor 26 receives the emergency alert signals from decoder 25 and determines whether the emergency alert function of television signal receiver 20 is activated based on data included in the emergency alert signals. According to this exemplary embodiment, processor 26 compares data in the emergency alert signals to data stored in memory 26 to determine whether the emergency alert function is activated. As will be described later herein, a setup process for the emergency alert function of television signal receiver 20 allows a user to select items such as an applicable geographical area(s), and type(s) of emergency events (e.g., tornado, toxic chemical spill, radiation leak, civil emergency, etc.) which activate the emergency alert function. According to an exemplary embodiment, when the emergency alert function is activated, processor 26 outputs one or more control signals which cause television signal receiver 20 to provide one or more alert outputs to thereby notify individuals of the emergency event. Further details regarding such functions will be provided later herein.

FPD 27 is operative to provide visual displays including information such as the operational state of the emergency alert function of television signal receiver 20, and information regarding emergency events. According to an exemplary embodiment, FPD 27 is a viewable display panel including one or more indicator elements. Such indicator elements may for example include any type of visual indicator such as light emitting diode (LED) or liquid crystal display (LCD) lamp(s), or the like. Such LEDs or LCDs may for example be included within a larger LED or LCD field, such as an LCD video or lighted LCD display panel. Additionally, the indicator elements of FPD 27 may include highlighted indicators, such as monochrome and/or colored liquid quartz display (LQD) indicators, plasma display indicators, and/or conventional lights used as consumer electronic product indicators.

The indicator elements of FPD 27 may for example reside outside the front panel of television signal receiver 20, such as for a portable (e.g., non-tethered) lighted panel designed for a wall and/or desk display apart from television signal receiver 20. This may allow, for example, hearing-impaired users to visually see an indicator for an emergency event set apart from television signal receiver 20. This may also allow various LED, LCD, LQD, plasma and/or cathode ray tube (CRT) devices to incorporate indicator elements for the emergency alert function as its total visual data field or a portion thereof. For example, the indicator elements may be highlighted as a portion of the visual data being displayed on an LCD panel playing recorded video content, such as content from a digital versatile disk (DVD) or the like.

Video processor 28 is operative to process signals including video signals. According to an exemplary embodiment, video processor 28 may process signals including embedded messages such as NWS text messages and/or other messages that provide details regarding emergency events. According to this exemplary embodiment, video processor 28 includes circuitry which enables auxiliary information displays such as closed caption displays, teletext displays, etc. Display 29 is operative to provide visual displays corresponding to processed signals provided from video processor 28. According to an exemplary embodiment, display 29 may provide visual displays including the aforementioned messages that provide details regarding emergency events.

Signal receiving element 31 is operative to receive signals including audio and/or video signals from signal sources, such as signal transmission source 10 in FIG. 1. Signal receiving element 31 may be embodied as any signal receiving element such as an antenna, input terminal or other element.

Tuner 32 is operative to tune signals including audio and/or video signals provided from signal receiving element 31 to thereby generate IF signals. According to an exemplary embodiment, tuner 32 may receive an automatic gain control (AGC) signal from IF processor 34, as indicated in FIG. 2. One or more IF filters 33 are operative to filter the IF signals provided from tuner 32. According to an exemplary embodiment, IF filter(s) 33 may be embodied as surface acoustic wave (SAW) filters having a split arrangement, wherein one IF filter 33 filters audio signals and another IF filter 33 filters video signals.

IF processor 34 is operative to process filtered IF signals provided from IF filter(s) 33. According to an exemplary embodiment, IF processor 34 demodulates the filtered IF signals, and may accommodate split audio and video IF signal inputs. BPF 35 is operative to filter audio IF signals. According to an exemplary embodiment, BPF 35 may provide a 4.5 MHz pass band and include filters for optimizing audio for both television and frequency modulation (FM) radio.

Audio processor 36 is operative to process audio signals provided from IF processor 34. According to an exemplary embodiment, audio processor 36 demodulates such audio signals to thereby generate demodulated audio signals. Audio processor 36 is further operative to amplify the demodulated audio signals. Speaker 37 is operative to aurally output the amplified audio signals provided from audio processor 36.

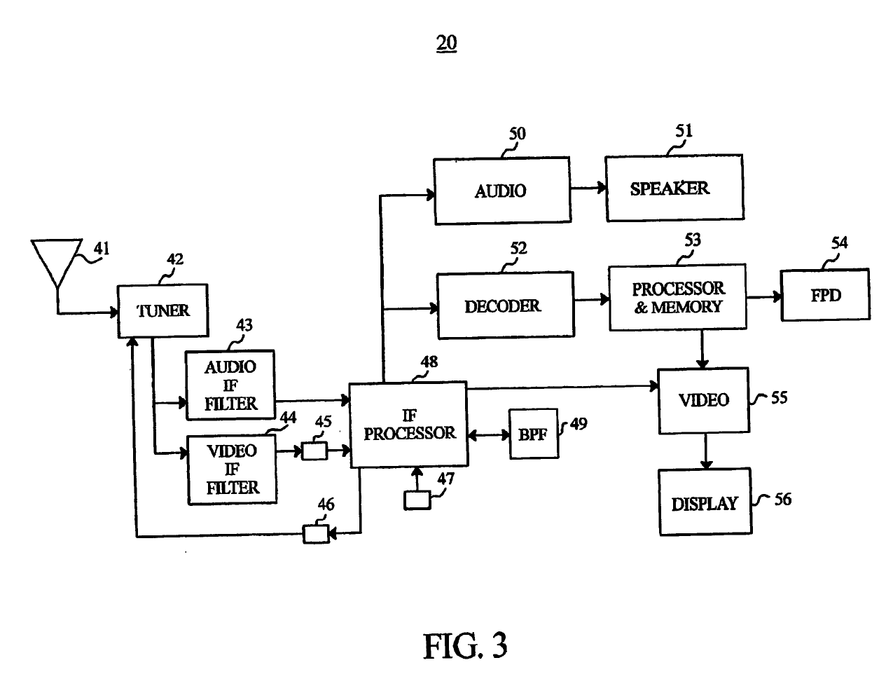

Referring to FIG. 3, a block diagram of television signal receiver 20 according to another exemplary embodiment of the present invention is shown. In FIG. 3, television signal receiver 20 comprises a signal receiving element 41, a tuner 42, an audio IF filter 43, a video IF filter 44, an FM mode switch 45, an AGC clamp 46, an AGC switch 47, an IF processor 48, a BPF 49, an audio processor 50, a speaker 51, a decoder 52, a processor and memory 53, a FPD 54, a video processor 55, and a display 56. Some of the foregoing elements may for example be embodied using integrated circuits (ICs). For clarity of description, certain conventional elements of television signal receiver 20 may not be shown in FIG. 3.

Signal receiving element 41 is operative to receive signals including audio and/or video signals from signal sources, such as signal transmission source 10 in FIG. 1. According to an exemplary embodiment, received audio signals may include digitally encoded emergency alert signals. Signal receiving element 41 may be embodied as any signal receiving element such as an antenna, input terminal or other element.

Tuner 42 is operative to tune signals including audio and/or video signals provided from signal receiving element 41. According to an exemplary embodiment, tuner 42 is capable of tuning audio signals on at least the following designated NWS frequencies: 162.400 MHz, 162.425 MHz, 162.450 MHz, 162.475 MHz, 162.500 MHz, 162.525 MHz and 162.550 MHz. Other frequencies may also be tuned. As previously indicated herein, such audio signals may include digitally encoded emergency alert signals. Tuner 42 may receive an automatic gain control (AGC) signal from IF processor 48, as indicated in FIG. 3. Audio IF filter 43 and video IF filter 44 are operative to filter audio and video IF signals provided from tuner 42, respectively. According to an exemplary embodiment, audio and video IF filters 43 and 44 may be embodied as surface acoustic wave (SAW) filters.

FM mode switch 45, AGC clamp 46, and AGC switch 47 are operative to facilitate proper audio demodulation by IF processor 48 (e.g., for FM radio and NWS audio signals). To this end, FM mode switch 45 is operative to disconnect the video path from IF processor 48, AGC clamp 46 is operative to maintain the AGC for tuner 42 at a constant level, and AGC switch 47 is operative to disable the AGC for IF processor 48. According to an exemplary embodiment, FM mode switch 45, AGC clamp 46, and AGC switch 47 are each controlled via a control signal provided from a processor (not shown).

IF processor 48 is operative to process filtered IF signals provided from audio and video IF filters 43 and 44. According to an exemplary embodiment, IF processor 48 demodulates the filtered IF signals, and accommodates the split audio and video IF signal inputs shown in FIG. 3. BPF 49 is operative to filter audio IF signals. According to an exemplary embodiment, BPF 35 may provide a 4.5 MHz pass band and include filters for optimizing audio for both television and FM radio.

Audio processor 50 is operative to process audio signals provided from IF processor 48. According to an exemplary embodiment, audio processor 36 demodulates such audio signals to thereby generate demodulated audio signals. Audio processor 50 is further operative to amplify the demodulated audio signals. Speaker 51 is operative to aurally output the amplified audio signals provided from audio processor 50.

Decoder 52 is operative to decode signals including demodulated audio signals provided from IF processor 48. According to an exemplary embodiment, decoder 52 decodes such audio signals to thereby extract digitally encoded FSK signals, which represent emergency alert signals indicating an emergency event. According to this exemplary embodiment, the emergency alert signals include data comprising SAME data associated with the emergency event. As previously indicated herein, SAME data comprises a digital code representing information such as the specific geographical area affected by the emergency event, the type of emergency event (e.g., tornado, toxic chemical spill, radiation leak, civil emergency, etc.), and the expiration time of the event alert. Other data and information may also be included in the emergency alert signals according to the present invention.

Processor and memory 53 are operative to perform various processing and data storage functions of television signal receiver 20. According to an exemplary embodiment, processor 53 receives the emergency alert signals from decoder 52 and determines whether the emergency alert function of television signal receiver 20 is activated based on data included in the emergency alert signals. According to this exemplary embodiment, processor 53 compares data in the emergency alert signals to data stored in memory 53 to determine whether the emergency alert function is activated. As will be described later herein, a setup process for the emergency alert function of television signal receiver 20 allows a user to select items such as an applicable geographical area(s), and type(s) of emergency events (e.g., tornado, toxic chemical spill, radiation leak, civil emergency, etc.) which activate the emergency alert function. According to an exemplary embodiment, when the emergency alert function is activated, processor 53 outputs one or more control signals which cause television signal receiver 20 to provide one or more alert outputs to thereby notify individuals of the emergency event. Further details regarding such functions will be provided later herein.

FPD 54 is operative to provide visual displays including information such as the operational state of the emergency alert function of television signal receiver 20, and information regarding emergency events. According to an exemplary embodiment, FPD 54 is a viewable display panel including one or more indicator elements. Such indicator elements may for example include any type of visual indicator such as LED or LCD lamp(s), or the like. Such LEDs or LCDs may for example be included within a larger LED or LCD field, such as an LCD video or lighted LCD display panel. Additionally, the indicator elements of FPD 54 may include highlighted indicators, such as monochrome and/or colored LQD indicators, plasma display indicators, and/or conventional lights used as consumer electronic product indicators.

The indicator elements of FPD 54 may for example reside outside the front panel of television signal receiver 20, such as for a portable (e.g., non-tethered) lighted panel designed for a wall and/or desk display apart from television signal receiver 20. This may allow, for example, hearing-impaired users to visually see an indicator for an emergency event set apart from television signal receiver 20. This may also allow various LED, LCD, LQD, plasma and/or CRT devices to incorporate indicator elements for the emergency alert function as its total visual data field or a portion thereof. For example, the indicator elements may be highlighted as a portion of the visual data being displayed on an LCD panel playing recorded video content, such as content from a DVD or the like.

Video processor 55 is operative to process signals including video signals. According to an exemplary embodiment, video processor 55 may process signals including embedded messages such as NWS text messages and/or other messages that provide details regarding emergency events. According to this exemplary embodiment, video processor 55 includes circuitry which enables auxiliary information displays such as closed caption displays, teletext displays, etc. Display 56 is operative to provide visual displays corresponding to processed signals provided from video processor 55. According to an exemplary embodiment, display 56 may provide visual displays including the aforementioned messages that provide details regarding emergency events.

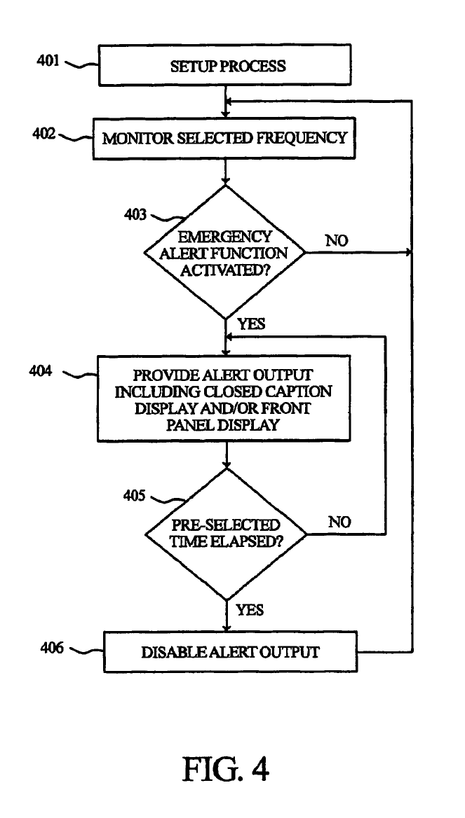

Referring to FIG. 4, a flowchart 400 illustrating exemplary steps according to the present invention is shown. The steps of FIG. 4 may be performed using either embodiment of television signal receiver 20 shown in FIGS. 2 and 3. However, for purposes of example and explanation, the steps of FIG. 4 will be described with reference to television signal receiver 20 of FIG. 2. The steps of FIG. 4 are merely exemplary, and are not intended to limit the present invention in any manner.

At step 401, a setup process for the emergency alert function of television signal receiver 20 is performed. According to an exemplary embodiment, a user performs this setup process by providing inputs to television signal receiver 20 (e.g., using a remote control device not shown) responsive to an on-screen menu displayed via display 29. Such an on-screen menu may for example be part of an electronic program guide (EPG) function of television signal receiver 20. According to an exemplary embodiment, the user may select at least the following items during the setup process at step 401:
A. Enable/Disable—The user may select whether to enable or disable the emergency alert function.
B. Frequency Selection—The user may select the monitoring frequency to tune to in order to receive emergency alert signals. For example, the user may select a frequency such as one of the following NWS frequencies: 162.400 MHz, 162.425 MHz, 162.450 MHz, 162.475 MHz, 162.500 MHz, 162.525 MHz and 162.550 MHz.
C. Event Types—The user may select one or more types of emergency events which activate the emergency alert function. For example, the user may designate that events such as civil emergencies, acts of war, and/or tornado warnings activate the emergency alert function, but that events such as thunderstorm warnings do not, etc. The user may also select whether the conventional warning audio tone provided by the NWS and/or other alert mechanism activates the emergency alert function. According to the present invention, different severity or alert levels may represent different “events.” For example, a thunderstorm watch may be considered a different event from a thunderstorm warning.
D. Geographical Areas—The user may select one or more geographical areas of interest. For example, the user may select a particular continent, country, region, state, area code, zip code, city, county, municipality, subdivision, and/or other definable geographical area.
E. Alert Outputs—The user may select one or more alert outputs to be provided when the emergency alert function is activated. For example, the user may select to aurally output a warning tone and/or an NWS audio message, and the desired volume of each. The user may also select to display an NWS text message (e.g., as a closed caption message) and/or to tune television signal receiver 20 to a specific channel. The user may also select whether to provide a visual display via FPD 27. Other types of alert outputs may also be provided according to the present invention.
F. Duration of Alert Outputs—The user may select a predetermined time period for which the one or more alert outputs will be provided when the emergency alert function is activated. After this predetermined time period elapses, the one or more alert outputs cease (at least temporarily), and television signal receiver 20 switches from one operating mode, e.g., the on mode, to another operating mode, e.g., the off/standby mode.
G. Time Period Between Repeat Events—The user may select a predetermined time period for repeat events. For example, after television signal receiver 20 provides an alert output for a particular emergency event and switches to the off/standby mode (as described in item F above), the emergency alert function will not be activated again for this same emergency event until after the predetermined time period for repeat events elapses. As previously indicated herein, different severity levels may represent different events.

According to the present invention, other menu selections may also be provided at step 401 and/or some of the menu selections described above may be omitted. Data corresponding to the user's selections during the setup process of step 401 is stored in memory 26.

At step 402, television signal receiver 20 monitors the frequency selected by the user during the setup process of step 401 (i.e., item B) for emergency alert signals. According to an exemplary embodiment, tuner 22 monitors the selected frequency and thereby receives incoming emergency alert signals. According to the present invention, television signal receiver 20 is capable of monitoring a frequency and receiving emergency alert signals during all modes of operation, including for example when television signal receiver 20 is turned on, turned off, and/or during playback of recorded audio and/or video content.

At step 403, a determination is made as to whether the emergency alert function of television signal receiver 20 is activated. According to an exemplary embodiment, processor 26 makes this determination by comparing data included in the incoming emergency alert signals to data stored in memory 26 from the setup process of step 401. As previously indicated herein, the emergency alert signals may include SAME data which represents information including the type of emergency event (e.g., tornado, toxic chemical spill, radiation leak, civil emergency, etc.) and the specific geographical area(s) affected by the emergency event. According to an exemplary embodiment, processor 26 compares this SAME data to the corresponding data from the setup process of step 401 (i.e., items C and D) stored in memory 26 to thereby determine whether the emergency alert function is activated. In this manner, the emergency alert function of television signal receiver 20 is activated only when the emergency event indicated by the emergency alert signals corresponds to the geographical area(s) and/or event type(s) designated by the user at step 401.

If the determination at step 403 is negative, process flow loops back to step 402 where tuner 22 continues to monitor the selected frequency. Alternatively, if the determination at step 403 is positive, process flow advances to step 404 where television signal receiver 20 provides one or more alert outputs to thereby notify individuals of the emergency event. According to an exemplary embodiment, processor 26 enables the one or more alert outputs in accordance with the user's selections during the setup process of step 401 (i.e., item E), and such alert outputs may be aural and/or visual in nature. For example, aural outputs such as a warning tone and/or an NWS audio message may be provided at step 404 via speaker 24 and/or speaker 37, and the volume of such aural outputs may be controlled in accordance with the volume level set by the user during the setup process of step 401.

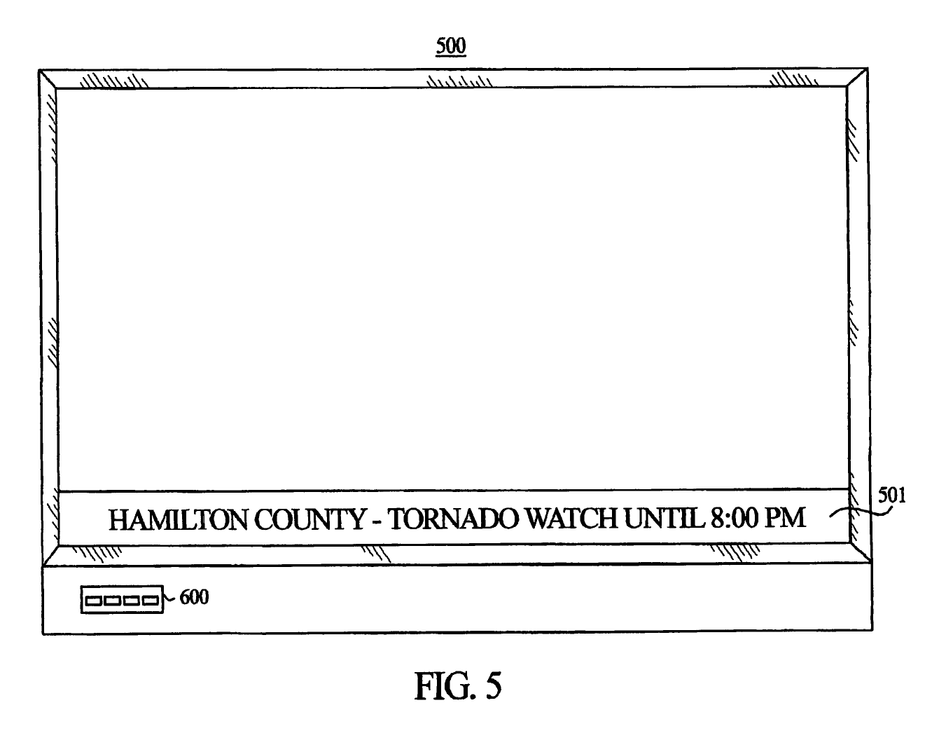

Visual outputs may also be provided at step 404 via FPD 27 and/or display 29 to notify individuals of the emergency event. According to an exemplary embodiment, an auxiliary information display such as an NWS text message (e.g., as a closed caption display) and/or a video output from a specific channel may be provided at step 404 via display 29. Also, at step 404, a visual display via FPD 27 may be provided. FIG. 5 is a diagram 500 illustrating an exemplary technique for providing a visual alert output according to the present invention. As indicated in FIG. 5, an auxiliary information display 501 comprises a text message providing details regarding an emergency event. Auxiliary information display 501 is only an example and other messages (e.g. scrolling messages) and/or display elements (e.g., icons, etc.) may be provided according to the present invention. Also shown in FIG. 5 is an emergency event indicator 600 which may constitute a portion of FPD 27. According to an exemplary embodiment, emergency event indicator 600 includes the one or more indicator elements of FPD 27 previously described herein.

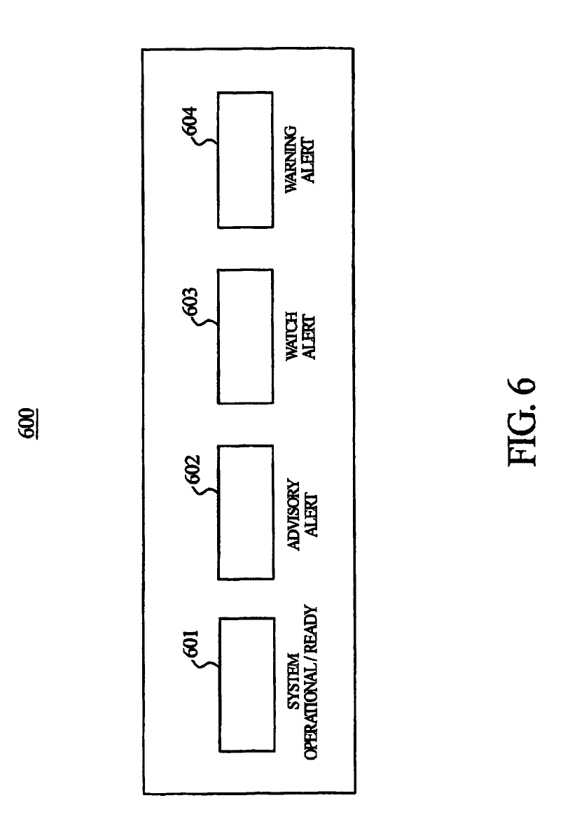

Referring to FIG. 6, further exemplary details of emergency event indicator 600 of FIG. 5 are shown. As indicated in FIG. 6, emergency event indicator 600 comprises indicator elements 601 to 604 which are capable of providing visual displays to indicate information such as the operational state of the emergency alert function of television signal receiver 20, and information regarding emergency events. As previously indicated herein, such indicator elements 601 to 604 may be embodied as any type of visual indicator such as LED, LCD, and/or LQD elements, or the like. For purposes of example, emergency event indicator 600 is shown in FIG. 6 as having four indicator elements. However, any number of such indicator elements may be provided according to the present invention.

According to the exemplary embodiment of FIG. 6, indicator element 601 may exhibit a green color and be illuminated when the emergency alert function of television signal receiver 20 is operational and emergency alert signals are being received. Indicator elements 602 to 604 may also exhibit different colors and be illuminated to provide visual information regarding emergency events. For example, indicator element 602 may exhibit a yellow color and be illuminated to indicate an advisory level alert. Similarly, indicator element 603 may exhibit an orange color and be illuminated to indicate a watch level alert, and indicator element 604 may exhibit a red color and be illuminated to indicate a warning level alert. As previously indicated herein, these different alert levels may represent different emergency events according to the present invention. Other colors than those described above, and/or different event labels than those shown in FIG. 6 may also be provided according to the present invention. Accordingly, emergency event indicator 600 shown in FIG. 6 is only an example and other types of indicators and/or displays may be provided according to the present invention. Other types of aural and/or visual alert outputs than those expressly described herein may also be provided at step 404 according to the present invention.

At step 405, a determination is made as to whether the one or more alert outputs have been provided for a pre-selected time period. As previously indicated herein, the user may designate this time period during the setup process at step 401 (i.e., item F). If the determination at step 405 is negative, process flow loops back to step 404 where television signal receiver 20 continues to provide the one or more alert outputs. Alternatively, if the determination at step 405 is positive, process flow advances to step 406 where television signal receiver 20 disables the one or more alert outputs. According to an exemplary embodiment, processor 26 outputs one or more control signals which disable the one or more alert outputs. In this manner, television signal receiver 20 provides the one or more alert outputs for only the pre-selected period of time specified by the user during the setup process at step 401.

After the one or more alert outputs are disabled at step 406, process flow loops back to step 402 where television signal receiver 20 continues to monitor the selected frequency and receive incoming emergency alert signals. However, according to an exemplary embodiment, the emergency alert function may not be activated again for the same emergency event (i.e., a repeat event) for a predetermined time period. As previously indicated herein, the user may select this predetermined time period for repeat events during the setup process of step 401 (i.e., item G), and different severity levels may represent different events. Accordingly, processor 26 disables the emergency alert function for a repeat emergency event for the predetermined time period specified by the user. In this manner, television signal receiver 20 will not provide an alert output again for the same emergency event until after this predetermined time period elapses.

As described herein, the present invention provides a television signal receiver capable of receiving emergency alert signals and providing alert outputs to notify individuals of emergency events. The present invention may be applicable to various apparatuses, either with or without a display device. Accordingly, the phrase “television signal receiver” as used herein may refer to systems or apparatuses capable of receiving and processing television signals including, but not limited to, television sets, computers or monitors that include a display device, and systems or apparatuses such as set-top boxes, video cassette recorders (VCRs), DVD players, video game boxes, personal video recorders (PVRs), computers or other apparatuses that may not include a display device.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A television signal processing system, comprising:
a tuner operative to tune a frequency including a signal indicating an emergency event; and
a processor operative to enable an alert output responsive to the emergency event corresponding to a geographical area selectable by a user.

2. The television signal processing system of claim 1, wherein the alert output comprises an auxiliary information display.

3. The television signal processing system of claim 2, wherein the auxiliary information display comprises a closed caption display.

4. The television signal processing system of claim 1, further comprising a display panel including at least one indicator element, and wherein the alert output comprises a visual display provided via the at least one indicator element.

5. The television signal processing system of claim 4, wherein the display panel comprises a plurality of indicator elements, and each indicator element exhibits a different color.

6. The television signal processing system of claim 1, wherein the processor enables the alert output for a first predetermined time period selectable by the user.

7. The television signal processing system of claim 1, wherein the alert output comprises a plurality of visual displays.

8. A television signal processor, comprising:
tuning means for tuning a frequency including a signal indicating an emergency event; and
processing means for enabling an alert output responsive to the emergency event corresponding to a predetermined event selectable by a user for providing an emergency alert function.

9. The television signal processor of claim 8, wherein the alert output comprises an auxiliary information display.

10. The television signal processor of claim 9, wherein the auxiliary information display comprises a closed caption display.

11. The television signal processor of claim 8, further comprising display means including at least one indicator element, and wherein the alert output comprises a visual display provided via the at least one indicator element.

12. The television signal processor of claim 11, wherein the display means comprises a plurality of indicator elements, and each indicator element exhibits a different color.

13. The television signal processor of claim 8, wherein the processing means enables the alert output for a first predetermined time period selectable by the user.

14. The television signal processor of claim 8, wherein the alert output comprises a plurality of visual displays.

15. A method for controlling a television signal processing system, comprising:
tuning a frequency including a signal indicating an emergency event; and
providing an alert output responsive to the emergency event corresponding to a geographical area and a predetermined event selectable by a user.

16. The method of claim 15, wherein the alert output comprises an auxiliary information display.

17. The method of claim 16, wherein the auxiliary information display comprises a closed caption display.

18. The method of claim 15, wherein the alert output is provided via at least one indicator element on a display panel of the television signal processing system.

19. The method of claim 18, wherein the at least one indicator element exhibits a color to indicate the emergency event.

20. The method of claim 15, wherein the alert output is provided for a first predetermined time period selectable by the user.

21. The method of claim 15, wherein the alert output comprises a plurality of visual displays.
